(19) United States
(12) Patent Application Publication
(10) Pub. No.: US 2011/0307536 A1
(43) Pub. Date: Dec. 15, 2011

(54) DIGITAL FILTER

(75) Inventor: Junichiro OYA, Miyagi-ken (JP)

(73) Assignee: ALPS ELECTRIC CO., LTD., Tokyo (JP)

(21) Appl. No.: 13/154,281

(22) Filed: Jun. 6, 2011

(30) Foreign Application Priority Data
Jun. 10, 2010 (JP) 2010-133039

(51) Int. Cl. G06F 17/10

(52) U.S. Cl. 708/301; 708/300

(57) ABSTRACT

The digital filter is connected to an upstream analog unit, changes bit data outputs corresponding to analog computation results every N clock pulse, operates in accordance with a clock in synchronization of the analog unit, and removes noise from the bit data output from the analog unit, the digital filter including an Nth-order sinc filter having a cascade of N sinc filters, each acquiring a moving average of a sample, and a moving average filter having a tap number of K connected to the output of the Nth-order sinc filter.

### CLAIM OF PRIORITY

This application claims benefit of Japanese Patent Application No. 2010-133039 filed on Jun. 10, 2010, which is hereby incorporated by reference.

### BACKGROUND OF THE INVENTION

1. Field of the Invention

The present invention relates to a digital filter having a cascade of multiple sinc filters, which each acquires a moving average of a sample.

2. Description of the Related Art

A known delta-sigma AD converter is connected to an upstream analog unit that performs analog computation and to a downstream digital filter that removes unwanted frequency components (noise) from the bit stream output from the analog unit. In general, an Nth-order sinc filter having a cascade of N sinc filters is used as a digital filter.

One of the circuits constituting the analog unit is a capacitive detector that detects a minute change in capacitance, converts the detected change to a digital signal, and takes in this digital signal (for example, refer to Japanese Unexamined Patent Application Publication No. 2006-253764). The capacitive detector, similar to the delta-sigma AD converter, includes an analog unit that integrates the change in capacitance and digitizes the integral value and a digital filter that removes noise components contained in bit sequence output from the analog unit and converts the bit sequence to multi-bit data. An Nth-order sinc filter may be used as such a digital filter.

### SUMMARY OF THE INVENTION

With a digital filter configured with an Nth-order sinc filter, depending on the clock number required for the upstream analog unit to output an analog computation result, the operation of the analog unit may not match the operation of the downstream Nth-order sinc filter, and noise may not be sufficiently attenuated because a notch cannot be formed at a noise position corresponding to an unwanted frequency component.

The present invention has been conceived in light of the problems mentioned above and provides a digital filter that matches the analog computation operation of an upstream analog unit and that has improved noise removal ability by forming a notch at a noise position in the output from the analog unit.

A digital filter according to the present invention is connected to an upstream analog unit, changes bit data outputs corresponding to analog computation results every N clock pulse, operates in accordance with a clock in synchronization of the analog unit, and removes noise from the bit data output from the analog unit, the digital filter including an Nth-order sinc filter having a cascade of N sinc filters, each acquiring a moving average of a sample; and a moving average filter having a tap number of K connected to the output of the Nth-order sinc filter.

With this configuration, the analog computation operation of the upstream analog unit matches the number of sinc filters in the digital filter and the tap number of the moving average filter, and the noise resistance can be improved by forming a notch in the noise passing range of the analog unit by forming a notch at a predetermined position on the basis of the number of the sinc filters and the tap number of the moving average filter.

In the digital filter described above, the Nth-order sinc filter may include an impulse response generator generating an impulse response of the digital filter, a multiplication unit determining the product of the bit data from the analog unit and the impulse response generated at the impulse response generator, an adder adding a current product output from the multiplication unit and a previous product output from the multiplication unit one clock pulse before, and a flip flop delaying the addition result from the adder by one clock pulse and supplying the delayed result to the adder.

With this configuration, since an impulse response is generated using the impulse response generator and filtering is performed by multiplying the bit data from the analog unit and the impulse response, the circuit size can be reduced, compared to when the sinc filters are constituted of delay elements.

In the digital filter described above, the impulse response generator may include a third-order differentiation generator generating a third-order differentiation value of the impulse response of the digital filter, and three integrators connected in series with the output of the third-order differentiation generator.

With this configuration, although the impulse response of the digital filter may be implemented using a table, etc., the circuit size becomes extremely large when a filter with a large tap number is provided. A small circuit is realized by providing hardware that takes advantages of the characteristic of the digital filter in which the values obtained by performing third-order differentiation of the impulse responses of the digital filter follow a specific rule.

In the digital filter described above, the Nth-order sinc filter may have a cascade of four sinc filters, each having a tap number of M, the moving average filter may have a tap number of four, and the analog unit may perform integration as analog computing every four clock pulse and has a noise passing region at fs/2, where fs represents a sampling frequency.

With this configuration, a digital filter having a frequency characteristic in which a notch is formed at fs/2, where fs represents a sampling frequency, with respect to the analog unit having noise passing region at fs/2.

### BRIEF DESCRIPTION OF THE DRAWINGS

FIG. 1 illustrates the configuration of a digital filter according to an embodiment of the present invention;

FIG. 2 illustrates the configuration of the digital filter having an impulse response generator;

FIG. 3 illustrates the configuration of the impulse response generator;

FIG. 4A illustrates the filter frequency characteristic of the digital filter according to this embodiment of the present invention;

FIG. 4B illustrates the filter frequency characteristic of a 4th-order sinc filter, which is a comparative example;

FIG. 5 illustrates the configuration of a capacitive detector;

FIG. 6 illustrates the connection switching timing of cross switches in the capacitive detector;

FIG. 7 illustrates another capacitive detector; and

FIG. 8 illustrates the connection switching timing of cross switches in the other capacitive detector.

### DESCRIPTION OF THE PREFERRED EMBODIMENTS

An embodiment of the present invention will be described in detail below with reference to the accompanying drawings.

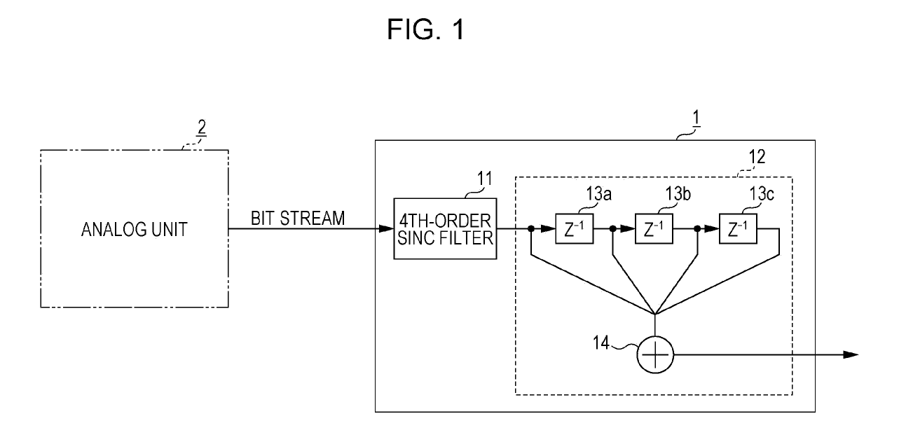

FIG. 1 illustrates the configuration of a digital filter 1 according to an embodiment of the present invention. The digital filter 1 according to this embodiment includes a 4th-order N filter 11 having a cascade of four sinc filters, which each acquires the moving average of a sample, and a moving average filter 12 having a tap number K and connected downstream of the 4th-order sinc filter 11. In this embodiment, the tap number of the moving average filter 12 matches the multiplier of the Nth-order sinc filter. The tap number, however, may be determined on the basis of a desired notch position, as described below. An analog unit 2 is connected upstream of the digital filter 1.

The 4th-order sinc filter 11 includes a cascade of four sinc filters, which are each constituted of a moving average filter having a tap number M. In this embodiment, to reduce the circuit size, an impulse response generator, which is described below, is used to provide circuitry having a function equivalent to a cascade of four sinc filters.

The moving average filter 12 is a moving average filter having a tap number of four and includes three delay elements 13a, 13b, and 13c, which are connected in series, and an adder 14 that adds the input to the delay element 13a and the outputs of the delay elements 13a, 13b, and 13c. The tap number of the moving average filter 12 is set in accordance with a desired notch position. When the tap number of the moving average filter 12 with respect to the 4th-order sinc filter 11 is set to four, notches can be formed at positions corresponding to ¼, ½, and ¾ of a sample frequency fs.

The analog unit 2 outputs bit data corresponding to the analog computation results (for example, analog integration) performed every predetermined number of clock pulses. In this embodiment, integration is performed every four clock pulse, and the integration result is converted to two bits and output. The timing of the change in the output of the analog unit 2 is matched to the operating timing of the fourth-order sinc filter 11 (four filter components) and the tap number (which is four) of the moving average filter 12.

The digital filter 1 according to this embodiment outputs digital data corresponding to a predetermined detection value from the binary bit stream output from the analog unit 2 and prevents noise with its filter function.

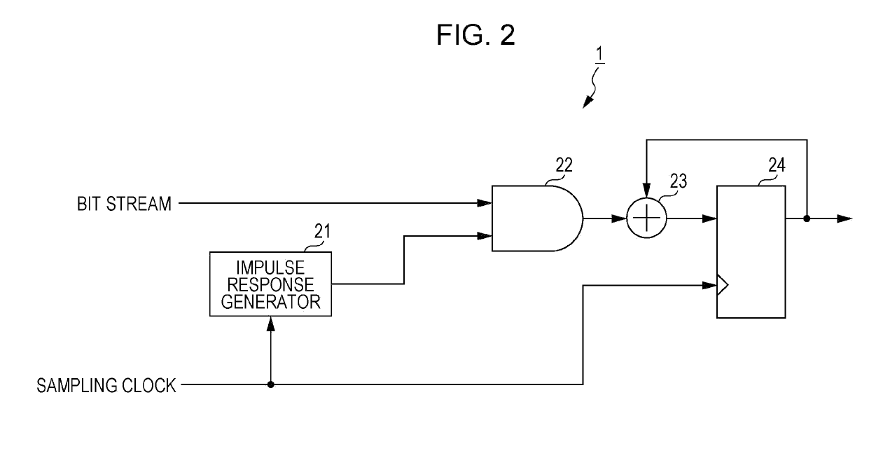

FIG. 2 illustrates the configuration of the digital filter 1 having an impulse response generator. The digital filter 1, which is illustrated in FIG. 2, includes an impulse response generator 21, a multiplication unit 22 that multiplies the impulse response generated at the impulse response generator 21 and the bit data from the analog unit 2, an adding unit 23 that adds the multiplication result of the previous sampling and the multiplication result of the current sampling, and a flip flop 24 that synchronizes the output from the adding unit 23 with the sampling clock and delays the output by one clock pulse.

The impulse response of the digital filter 1 may be implemented using a table, etc., but, when a filter having a large tap number is provided, the circuit will be extremely large. The present invention provides a small circuit by providing hardware that takes advantages of the characteristic of the digital filter 1 according to this embodiment in which the values obtained by performing third-order differentiation of the impulse responses of the digital filter 1 (a combination of the 4th-order sinc filter 11 and the moving average filter 12 having a tap number of 4) follow a specific rule.

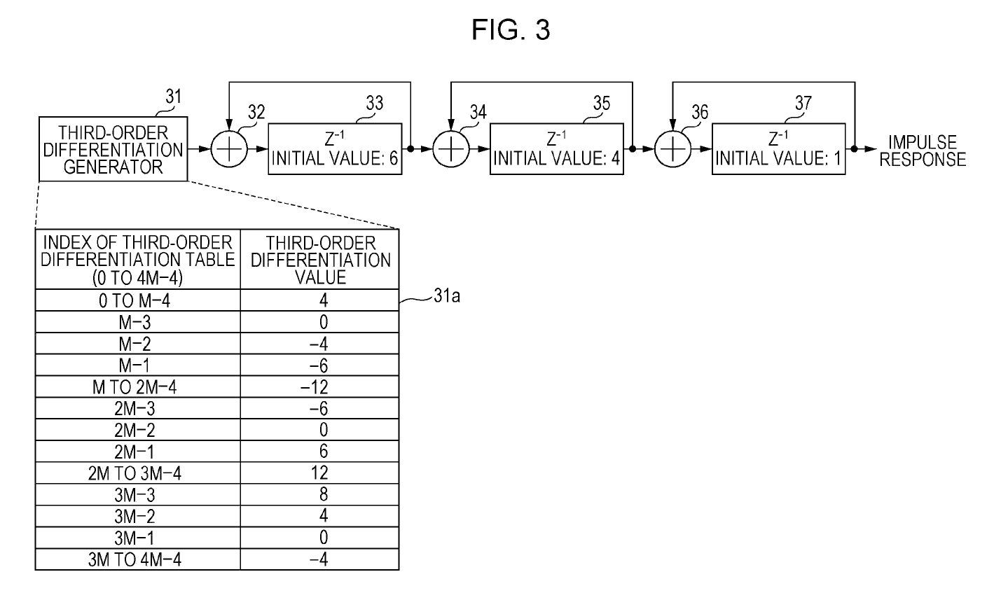

FIG. 3 illustrates the configuration of the impulse response generator 21. A third-order differentiation generator 31 includes a third-order differentiation table 31a, which contains the third-order differentiation values of the impulse responses of the digital filter 1. The third-order differentiation values in the third-order differentiation table 31a correspond to indexes (0 to 4M−4). Reference character M represents the tap number of each filter. The output of the third-order differentiation generator 31 is connected in series to three integrators. The integrators each include an adder (32, 34, or 36) and a delay element (33, 35, or 37). In this way, the original impulse response is generated by performing third-order integration of a third-order differentiation value.

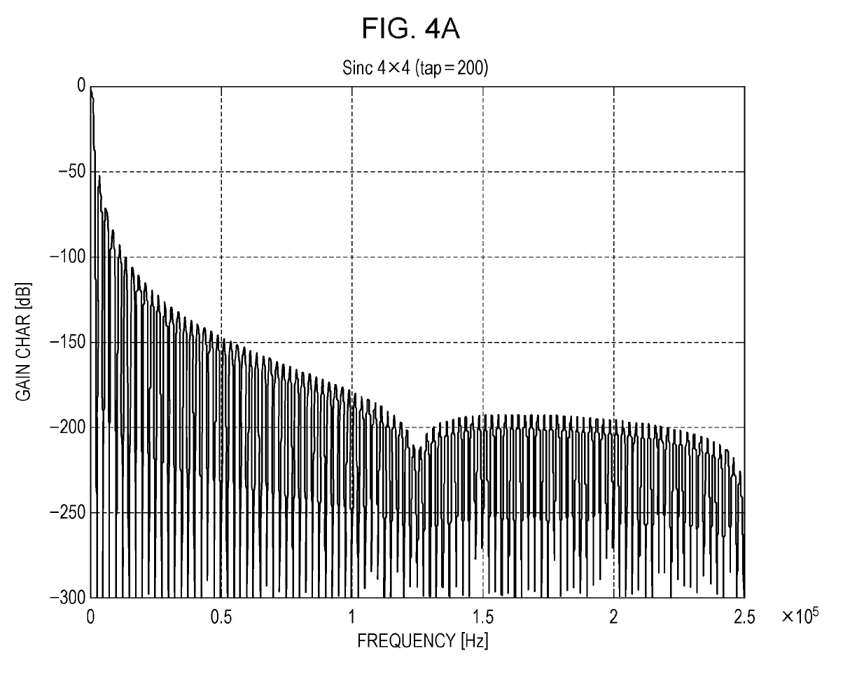

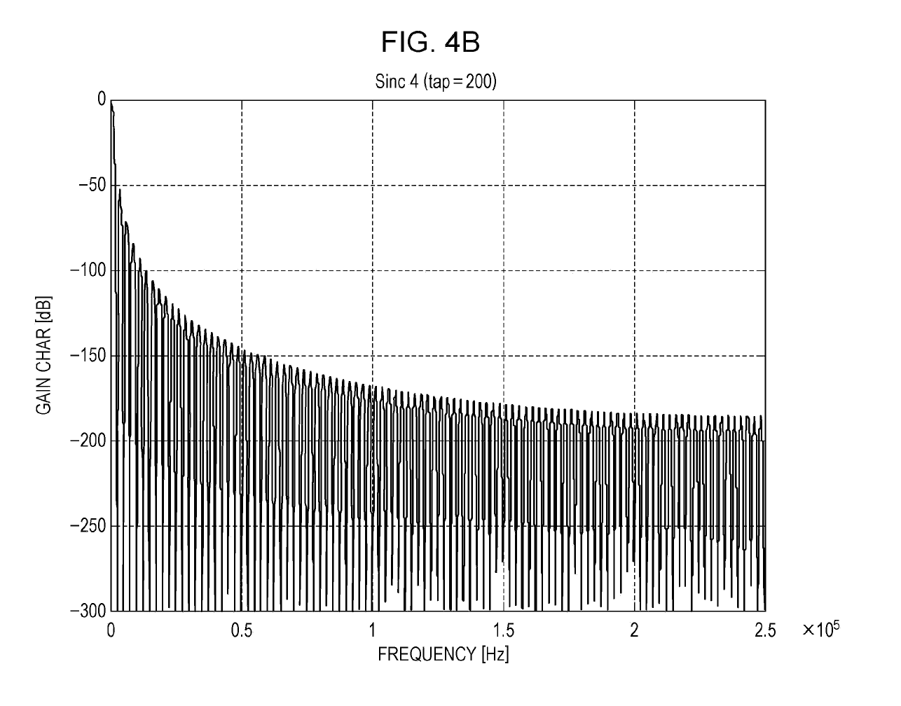

FIG. 4A illustrates the filter frequency characteristic of the digital filter 1, and FIG. 4B illustrates the filter frequency characteristic of only the 4th-order sinc filter 11. The frequency range illustrated in FIGS. 4A and 4B is up to ½ of the sample frequency fs.

As illustrated in FIG. 4A, as the filter frequency characteristic of the digital filter 1 according to this embodiment, notches are formed at positions corresponding to ¼ and ½ of the sample frequency fs. If the analog unit 2 has a noise passing band at a position corresponding to ¼ or ½ of the sample frequency fs, this can be removed by the digital filter 1.

As illustrated in FIG. 4B, the filter frequency characteristic of the 4th-order sinc filter 11 is that notches are not formed at predetermined positions (such as the position corresponding to ¼ or ½ of the sample frequency fs). Therefore, noise resistance is lower than that of the digital filter 1 and a decrease in accuracy is less likely to occur.

The analog unit 2, which performed integration after every four clocks, converts the integration results to two bits via a comparator, outputs the converted two bits, and has a noise passing band at a position corresponding to ½ of the sample frequency fs, is described below. The analog unit 2 may be a capacitive detector that detects a minute change in capacitance, converts the detected change to a digital signal, and takes in the digital signal.

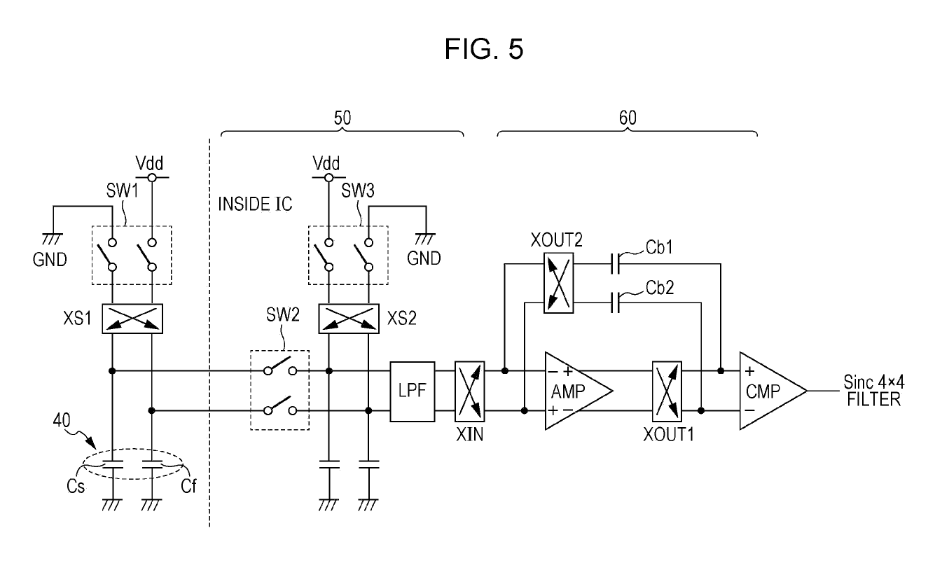

FIG. 5 illustrates the configuration of the capacitive detector. The capacitive detector is connected to a sensor unit 40 of a capacitive touch sensor module. In the present invention, the sensor unit 40 is not limited to an input device, such as a touch panel. The sensor unit 40 has capacitors having capacitances Cs and Cf to be detected. The capacitance Cf changes when, for example, a finger approaches the capacitor, whereas the capacitance Cs is not affected by an approaching finger. The capacitances Cs and Cf can be connected to a first fixed voltage (Vdd) and a second fixed voltage (ground voltage GND) via a switch SW1, and the fixed voltages applied to the capacitances Cs and Cf can be switched by a cross switch XS1.

The capacitive detector includes a chopping filter 50 connected to the sensor unit 40 and an integrator 60 connected to the output of the chopping filter 50. The chopping filter 50 converts the capacitance detected at the sensor unit 40 to a charge quantity and converts a low-frequency exogenous noise to high-frequency noise. The chopping filter 50 may include a base-charge cancelling mechanism that cancels the sensor capacitance Cs, which is normally not detected. The chopping filter 50 is connected to the capacitances Cs and Cf of the sensor unit 40 via the switch SW2. The chopping filter 50 is capable of connecting the capacitance Cs and Cf connected via the switch SW2 to the first fixed voltage (Vdd) and the second fixed voltage (ground voltage GND) via a switch SW3 and is capable of switching the fixed voltages applied to the capacitances Cs and Cf by a cross switch XS2. The chopping filter 50 includes a low-pass filter LPF connected in parallel to the capacitances Cs and Cf via the switch SW2 and a cross switch XIN that inputs the balanced output of the low-pass filter LPF to the downstream integrator 60.

The integrator 60 converts and amplifies the charge quantities corresponding to the capacitance Cf to a voltage as it integrates the electric signals (charge quantities) output from the chopping filter 50 and functions as a delta-sigma modulator that bears part of function of the AD converter. The integrator 60 includes an operational amplifier AMP and a comparator CMP. The balanced output of the operational amplifier AMP is connected to a cross switch XOUT1, and feedback capacitors (Cb1 and Cb2) are connected to both the output of the cross switch XOUT1 and the input of the operational amplifier AMP. A cross switch XOUT2 is disposed on the line that feeds back the voltages of the feedback capacitors (Cb1 and Cb2) to the input of the operational amplifier AMP. The balanced output of the operational amplifier AMP is connected to the input of the comparator CMP via the cross switch XOUT1.

A cycle of a change in the output of the comparator CMP in the capacitive detector having the configuration described above will be described below.

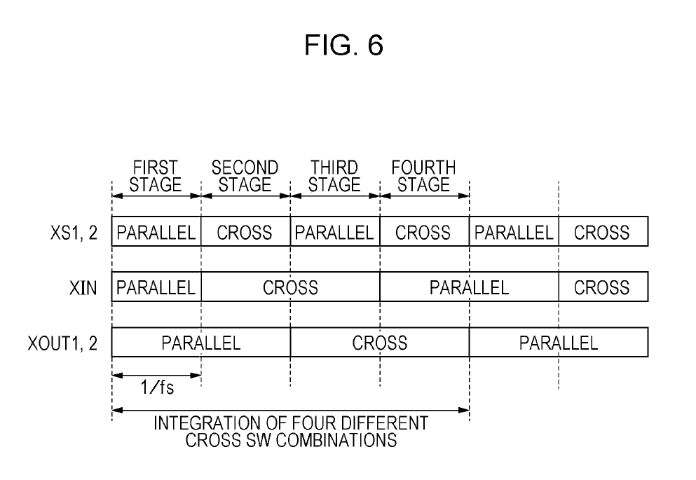

FIG. 6 illustrates the parallel connection and cross connection of the cross switches XS1, XS2, XIN, XOUT1 and XOUT2 in a cycle of completing an operation of integration. As illustrated in FIG. 6, a cycle of an integration operation has four stages, i.e., first to fourth stages, each of which is equivalent to 1/fs, where fs represents the sampling frequency fs.

In the first stage, the cross switches XS1, XS2, XIN, XOUT1, and XOUT2 are connected in parallel. Then, when the switches SW1 and SW3 are turned off after being on for a predetermined amount of time, the switch SW2 is turned on for a predetermined amount of time. Then, the switch SW2 is turned off, and the difference in the charges stored in two capacitors Cmod (on the right of the switch SW2) is transferred to the integrator 60.

In the second stage, the cross switches XS1, XS2, and XIN are cross connected, and the cross switches XOUT1 and XOUT2 are connected in parallel. Then, when the switches SW1 and SW3 are turned off after being on for a predetermined amount of time, the switch SW2 is turned on for a predetermined amount of time. Then, the switch SW2 is turned off, and the difference in the charges stored in the two capacitors Cmod (on the right of the switch SW2) is transferred to the integrator 60.

In the third stage, the cross switches XS1 and XS2 are connected in parallel, and the cross switches XIN, XOUT1, and XOUT2 are cross connected. Then, when the switches SW1 and SW3 are turned off after being on a predetermined amount of time, the switch SW2 is turned on for a predetermined amount of time. Then, the switch SW2 is turned off, and the difference in the charges stored in the two capacitors Cmod (on the right of the switch SW2) is transferred to the integrator 60.

In the fourth stage, the cross switches XS1 and XS2 are cross connected, the cross switch XIN is connected in parallel, and the cross switches XOUT1 and XOUT2 are cross connected. Then, when the switches SW1 and SW3 are turned off after being on for a predetermined amount of time, the switch SW2 is turned on for a predetermined amount of time. Then, the switch SW2 is turned off, and the difference in the charges stored in the two capacitors Cmod (on the right of the switch SW2) is transferred to the integrator 60.

In this way, by completing the first to fourth stages, the integration result (two bits) is output from the comparator CMP.

With the capacitive detector, low-frequency noise generated or applied upstream is reduced by the cross switches XS1, XS2, and XIN. Furthermore, low-frequency noise (flicker noise etc.) generated at the operational amplifier AMP is reduced by the cross switches XIN, XOUT1, and XOUT2.

The capacitive detector operates in synchronization with the system clock of the digital filter 1, and the output of the comparator CMP changes every four clock pulse. The bit stream output from the comparator CMP contains noise at a position corresponding to fs/2, where fs represent the sampling frequency fs.

By connecting the digital filter 1 according to this embodiment downstream of the capacitive detector, a bit stream that changes every four clock pulse is output from the capacitive detector. At the digital filter 1, the processing at the upstream 4th-order sinc filter 11 is completed in four clock pulses, and the processing at the downstream moving average filter 12 is completed in four clock pulses. Thus, the analog computation operating period of the capacitive detector, which is the upstream analog unit 2, and the period of the downstream digital filter 1 completely match, and efficient computation is performed. Moreover, by connecting the moving average filter 12, which has a tap number of four, downstream of the 4th-order sinc filter 11, a notch is formed at the position corresponding to fs/2, where fs represents sampling frequency fs, which is the noise passing range of the analog unit 2, and the detection accuracy is improved by noise attenuation.

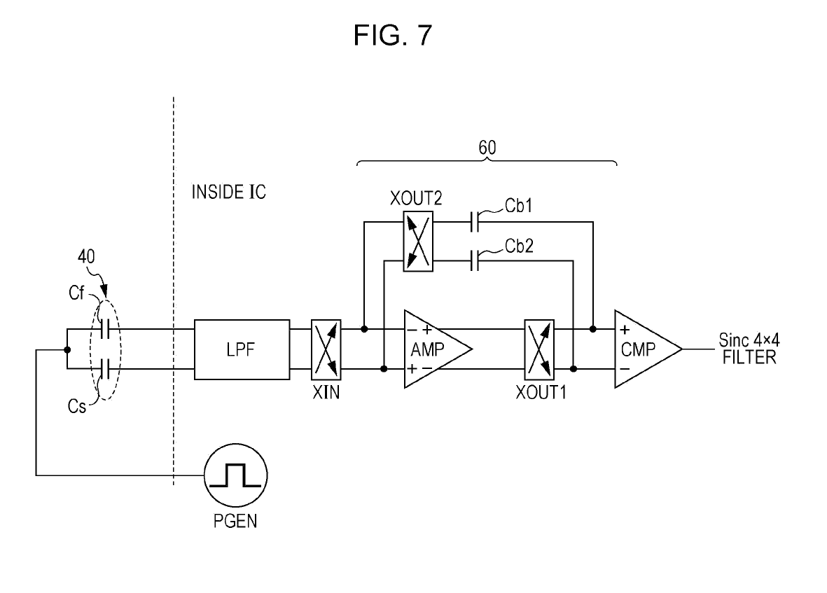

FIG. 7 illustrates another capacitive detector. The capacitive detector is configured such that pulses are applied to the capacitances Cs and Cf of the sensor unit 40. A pulse generator PGEN generates pulses.

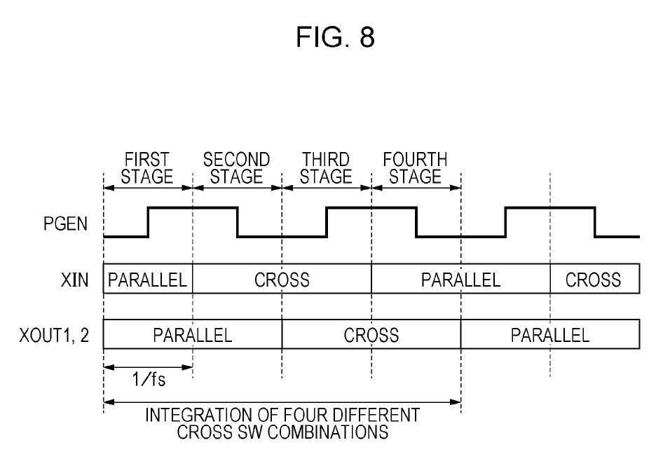

FIG. 8 illustrates a combination of cross switches XIN, XOUT1, and XOUT2 and pulses in the capacitive detector. In the first stage, the cross switch XIN is connected in parallel, the cross switches XOUT1 and XOUT2 are connected in parallel, the first half of the pulse is low level, and the second half of the pulse is high level. In the second stage, the cross switch XIN is cross connected, the cross switches XOUT1 and XOUT2 are connected in parallel, the first half of the pulse is high level, and the second half of the pulse is low level. In the third stage, the cross switch XIN is cross connected, the cross switches XOUT1 and XOUT2 are cross connected, the first half of the pulse is low level, and the second half of the pulse is high level. In the fourth stage, the cross switch XIN is connected in parallel, the cross switches XOUT1 and XOUT2 are cross connected, the first half of the pulse is high level, and the second half of the pulse is low level.

One operation of integration is performed at the integrator 60 in one cycle from the first stage to the second stage. In this way, in the capacitive detector illustrated in FIG. 8, the integration output of the comparator CMP changes every four clock pulses.

The present invention is not limited to the embodiment described above and may include variations within the scope of the invention. For example, the analog unit 2 is not limited to a capacitive detector and may be another type of integrator.

The present invention provides a digital filter having a cascade of sinc filters.

What is claimed is:

1. A digital filter being connected to an upstream analog unit, changing bit data outputs corresponding to analog computation results every N clock pulse, operating in accordance with a clock in synchronization of the analog unit, and removing noise from the bit data output from the analog unit, the digital filter comprising:
an Nth-order sinc filter having a cascade of N sinc filters, each acquiring a moving average of a sample; and
a moving average filter having a tap number of K connected to the output of the Nth-order sinc filter.

2. The digital filter according to claim 1, wherein the Nth-order sinc filter includes
an impulse response generator generating an impulse response of the digital filter,
a multiplication unit determining the product of the bit data from the analog unit and the impulse response generated at the impulse response generator,
an adder adding a current product output from the multiplication unit and a previous product output from the multiplication unit one clock pulse before, and
a flip flop delaying the addition result from the adder by one clock pulse and supplying the delayed result to the adder.

3. The digital filter according to claim 2, wherein the impulse response generator includes
a third-order differentiation generator generating a third-order differentiation value of the impulse response of the digital filter, and
three integrators connected in series with the output of the third-order differentiation generator.

4. The digital filter according to claim 1, wherein,
the Nth-order sinc filter has a cascade of four sinc filters, each having a tap number of M,
the moving average filter has a tap number of four, and
the analog unit performs integration as analog computing every four clock pulse and has a noise passing region at fs/2, where fs represents a sampling frequency.
